(19) United States
(12) Patent Application Publication
(10) Pub. No.: US 2026/0306906 A1
(43) Pub. Date: Oct. 8, 2026

(54) OBJECT PATH EVALUATION SYSTEM

(71) Applicant: PGA TOUR Enterprises, LLC, Ponte Vedra Beach, FL (US)

(72) Inventors: Jonas Gredenhag, Ponte Vedra Beach, FL (US); Spencer Border, Ponte Vedra Beach, FL (US); Kevin Kerr, Ponte Vedra Beach, FL (US); Jeremy Craven, Ponte Vedra Beach, FL (US); Barry Walker, Ponte Vedra Beach, FL (US)

(73) Assignee: PGA TOUR Enterprises, LLC, Ponte Vedra Beach, FL (US)

(21) Appl. No.: 19/641,305

(22) Filed: Apr. 7, 2026

Related U.S. Application Data
(63) Continuation of application No. PCT/US26/22663, filed on Apr. 7, 2026.
(60) Provisional application No. 63/784,951, filed on Apr. 7, 2025.

(51) Int. Cl. A63B 24/00; G06T 7/246; G06T 7/60; G06T 7/73

(52) U.S. Cl. CPC A63B 24/0021; G06T 7/248; G06T 7/251; G06T 7/60; G06T 7/74; G06T 7/75; A63B 2024/0028; G06T 2207/30224

(57) ABSTRACT

An object path evaluation system may include a data collection system including imaging sensors that automatically track ball movement along a surface. The imaging sensors are calibration to the surface to capture ball position coordinates and timestamps with respect to a path of the ball movement. A surface speed processor processes paths of a plurality of balls along the surface captured during live play to generate surface speed at the ball positions and interpolates the surface speeds to generate a continuous surface speed measurement across the surface. The surface speed measurements may be provided in stimp units. The continuous surface speeds may be incorporated into a heatmap including a visualization of the surface.

### CROSS-REFERENCE TO RELATED APPLICATIONS

The present application claims priority to and the benefit of the filing of U.S. Provisional Patent Application No. 63/784,951, filed Apr. 7, 2025, and International Application No. PCT/US26/22663, filed Apr. 7, 2026, the entire contents of both of which are incorporated herein by reference.

### TECHNOLOGY

The present application is directed to determination of surface speed of a surface utilizing imaging-based, such as camera-based, tracking data. The present application is also directed to generating actual and simulated paths of objects from imagining-based tracking data for use in various applications such as those utilizing visualization or predictions to improve broadcast production, score tracking, object tracking, among others.

### SUMMARY

In one aspect, a system for calculating surface speed of a playing surface from image-captured ball movement, may include one or more processors; and one or more tangible, non-transitory computer-readable media storing program instructions that, when executed by the one or more processors, cause the system to: receive or generate tracking data, the tracking data being generated from imaging data of the ball captured by one or more imaging sensors configured to track movement of the ball along the playing surface, the imaging sensors comprising cameras, LiDAR, or combinations thereof, the tracking data comprising sequential points with position coordinates and associated timestamps; calculate a total deceleration from the tracking data; obtain elevation data for the sequential points from terrain data and calculate a slope component; isolate a friction component by removing the slope component from the total deceleration; convert the friction component to a surface speed value using a physics-based conversion factor; and output the surface speed value as a measurement of surface speed for the playing surface.

In another aspect, a method for calculating surface speed of a playing surface from image-captured ball movement may include receiving or generating tracking data, the tracking data being generated from imaging data of the ball captured by one or more imaging sensors configured to track movement of the ball along the playing surface, the imaging sensors comprising cameras, LiDAR, or combinations thereof, the tracking data comprising sequential points with position coordinates and associated timestamps; calculating a total deceleration from the tracking data; obtaining elevation data for the sequential points from terrain data and calculating a slope component; isolating a friction component by removing the slope component from the total deceleration; converting the friction component to a surface speed value using a physics-based conversion factor; and outputting the surface speed value as a measurement of surface speed for the playing surface.

In yet another aspect, a system for generating tracking data representing movement of a ball along a playing surface, may include one or more processors; and one or more tangible, non-transitory computer-readable media storing program instructions that, when executed by the one or more processors, cause the system to: capture image frames from one or more cameras having fields of view over the playing surface; detect and track the ball in successive frames using computer vision to determine pixel locations of the ball; transform the pixel locations to position coordinates within a mapped coordinate system using a coordinate translator configured with anchor points corresponding to identifiable features on or adjacent to the playing surface; associate timestamps synchronized to a common time base with the position coordinates; and output sequential points comprising the position coordinates and associated timestamps as tracking data for surface speed calculations.

In still another aspect, a system for detecting lip-out events during ball movement along a playing surface may include one or more processors; and one or more tangible, non-transitory computer-readable media storing program instructions that, when executed by the one or more processors, cause the system to: receive or generate tracking data, the tracking data being generated from imaging data of the ball captured by one or more imaging sensors configured to track movement of the ball along the playing surface, the imaging sensors comprising cameras, LiDAR, or combinations thereof, the tracking data comprising sequential points with position coordinates and associated timestamps; determine whether a path segment intersects with a perimeter of a hole on the playing surface; calculate angle changes between consecutive segments of the path in a vicinity of the intersection; classify the path as a lip-out when an angle change exceeds a threshold and the segment intersects with the hole perimeter; and output a lip-out classification.

### DRAWINGS

The novel features of the described embodiments are set forth with particularity in the appended claims. The described embodiments, however, both as to organization and manner of operation, may be best understood by reference to the following description, taken in conjunction with the accompanying drawings in which:

FIG. 1 schematically illustrates an object path evaluation system according to various embodiments described herein;

FIG. 2 schematically illustrates aspects of a data collection system according to various embodiments described herein;

FIG. 3 schematically illustrates an object path evaluation system according to various embodiments described herein;

FIG. 4 schematically illustrates an object path evaluation system according to various embodiments described herein; and

FIG. 5 schematically illustrates an object path evaluation system according to various embodiments described herein.

### DESCRIPTION

Among other things, the present disclosure describes an object path evaluation system that may be configured to generate surface speed of a surface utilizing imaging technology that tracks movement of objects along the surface. The surface speed may be provided in a unit of measure suitable for its useful application. For example, in golf, stimp refers to the measurement of the speed of a putting green, expressed in feet. Historically, stimp is conventionally tied to use of a Stimpmeter that standardizes green speed determinations as to the stimp unit. The Stimpmeter includes a 36-inch aluminum bar with a V-shaped groove and notches for releasing a golf ball at a controlled angle. By measuring the distance a ball rolls on level ground after being released from the device, the stimp rating provides an objective numerical value for green speed. This reading helps players anticipate how fast or slow greens will play, with higher stimp values indicating faster greens. The Stimpmeter is widely used by golf courses to maintain consistent playing conditions, guide maintenance practices, and prepare greens for tournaments, and by golfers when analyzing greens in anticipation of a putt. To ensure accuracy, readings are taken on flat sections of greens, with multiple rolls performed in opposite directions to account for slope and grain effects. The average distance of these rolls becomes the official stimp reading. Typical stimp ratings range from 7 feet on slower greens to over 13 feet on championship-level greens. It takes considerable time and effort to collect sufficient stimp readings throughout a green and teams are often required to do so on all greens of a course prior to a tournament. Stimp measurements are typically taken on a level surface. However, greens, especially competitive greens, are not reasonably level across their full surface. To achieve an estimated measurement of stimp along slopes, the Brede Equation may be used or stimp readings from both uphill and downhill directions of the slope may be averaged, both exacerbating the time and effort to collect stimp. The stimp of a surface, or more generally the surface speed stimp represents, also changes over time. For example, moisture reduces stimp as does grass growth. This is why stimp readings taken in the morning may be lower than later in the day due to sun drying morning dew or residual moisture.

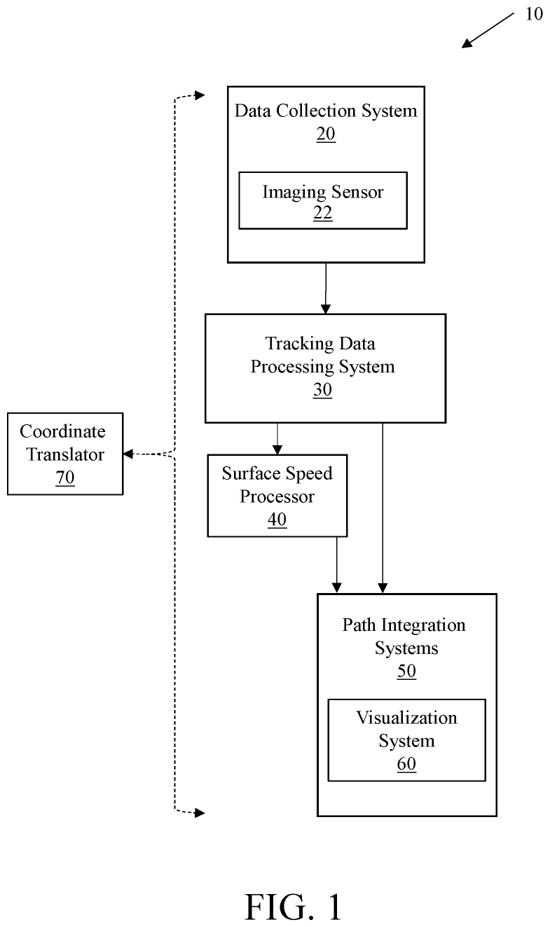

FIGS. 1-5 illustrate various components and operations of an object path evaluation system 10 for evaluating paths of objects to generate surface speed measurements of a surface, generate actual paths, simulated paths, or combination thereof for use in various applications wherein like numbers represent like features. For brevity and ease of understanding the various operations and features described herein, the surface will generally be referred to as a green surface of a golf course, and the object being a golf ball putted along the green. However, the system 10 may be similarly employed to measure surface speed of other surfaces of a golf course, e.g., fairway, or surfaces used in other contexts such as baseball fields or soccer pitches. The force causing the movement of the ball is also non-limiting. For example, a golf ball that moves along a green may have been hit onto or otherwise caused to move along the green in a manner that is not a putt.

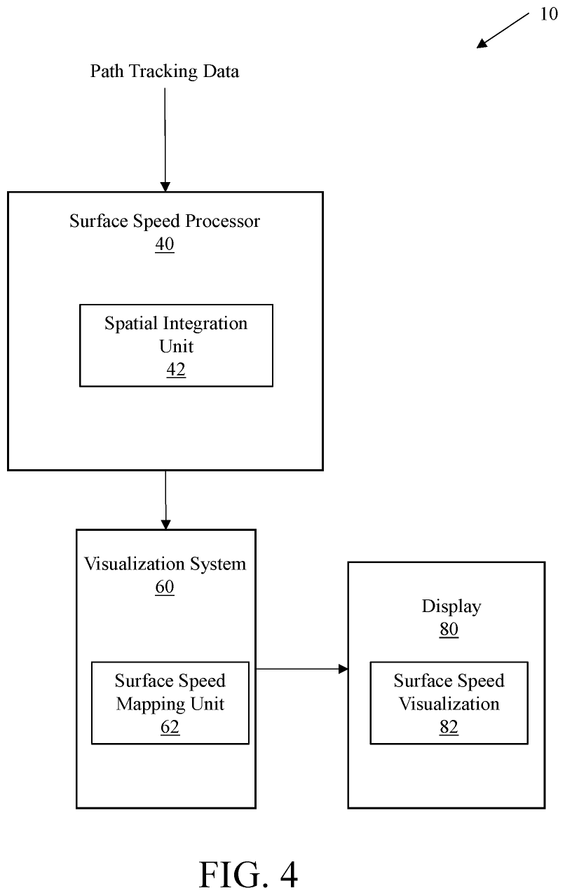

With reference to FIG. 1, the object path evaluation system 10 may include or incorporate operations or outputs of a data collection system 20, tracking data processing system 30, and surface speed processor 40. The data collection system 20 may use imaging sensors 22 to track ball movement along a surface. This tracking data may include ball position coordinates and timestamps corresponding to the coordinates. The tracking data may therefore include tracked ball paths represented by consecutive path points (coordinates) representing the path at each timestamp. Consecutive points may be connected by line segments. For instance, the path may be represented as an ordered sequence of coordinate points, and each segment is formed by connecting adjacent points in this sequence. Each segment, therefore, is representative of movement between two consecutive recorded positions. The system 10 may process these paths and output surface speed data with respect to a surface determined from image-based data captured by the data collection system 20, which may include interpolated, extrapolated, measurements. For instance, the data collection system 20 may capture tracking data of ball paths across a surface during a golf event. The tracking data processing system 30 may process this data to, e.g., extract path parameters. The surface speed processor 40 use the path and path parameters to calculate surface speed with respect to the points in the captured path. The surface speeds from multiple paths may be interpolated across the surface to generate a continuous surface speed across the surface. The surface speed processor 40 may be configured to output surface speeds and dynamically update surface speeds to maintain an accurate measurement of current surface speed during play. In some embodiments, the tracking data collection system 20 is configured to output actual paths, simulated paths, reconstructed paths, or combination thereof may be output from the tracking data processing system 30 to one or more path integration systems 50. As described in more detail below, the paths, surface speeds, or combination thereof may be used to generate path visualizations for broadcast enhancement system 52, scoring/tracking system 54, course setup system 56, digital enhancement system 58, or other path integration system 50. For example, surface speed data may be used in operations of one or more path integration systems 50 to generate products and provide services that integrate the surface speeds. For example, surface speed outputs of the surface speed processor 40 may be utilized by a visualization system 60 to generate a surface speed visualization 82 (see FIG. 4). The surface speed visualization 82 may include graphical representations of surface speed rendered on a representation of the surface it corresponds.

The system 10 may include or received tracking data captured by a data collection system 20 comprising one or more imaging sensors positioned around an area in which the operations of the system 10 are to be applied. The data collection system 20 may track ball movement to capture precise ball position coordinates with timestamps with respect to a path of the ball along a surface. In various embodiments, the system 10 is configured to determine surface speed, ball paths, or both utilizing camera-based tracking of ball movement during event play, such as during professional golf tournament play. The data collection system 20 may include one or more local or remote processors for path coordinate identification and timestamp association.

Imaging sensors 22 may be operated by a human, robot, or be fully autonomous. Imaging sensors 22 may operate in the visual spectrum and/or an optical spectrum to include one or more of the visual spectrum, ultraviolet spectrum, or infrared spectrum. The data collection system 20 or imaging sensors 22 thereof may comprise tracking logic with respect to one or more of recognition, detection, computer vision, or other image analysis operations. For example, the imaging sensors 22 or data collection system 20 may be configured with computer vision for object detection to identify and classify objects, e.g., balls, tracking to identify and track ball movement along a surface within its field of view, to output coordinates with timestamps. The resolution of the imaging sensors 22 may impact the accuracy of determinations of surface speed or path. Thus, higher resolution imaging sensors 22 may be used to increase accuracy. In various embodiments, the imaging sensors 22 comprise cameras. In some embodiments, the imaging sensors 22 may comprise LiDAR.

The area, e.g., course or portions thereof comprising the surface upon which surface speeds, paths, or both are to be tracked, may be mapped with respect to a coordinate system and imaging sensors 22 may be configured to track balls or other movements relative to the coordinate system. For example, the area may be topographically mapped to include elevation and terrain features and the imaging sensors 22 or data collection system 20 may be calibrated to the area with respect to the coordinate system such that position of tracked objects may tracked within the imaging data to precise position coordinates, e.g., (x, y), within a coordinate space. The topographical mapping may be performed using suitable mapping technologies such as LiDAR, photogrammetry, GPS surveying, topographic surveying, or the like. In some embodiments, individuals on foot, aircraft, drones, or robots may survey the area utilizing such technologies. In one example, LiDAR and photogrammetry devices are carried by remotely piloted or other aircraft as well as by walking or robotic ground-based devices are used to collect mapping data. The topographical mapping may include a coordinate system and associated terrain features with corresponding coordinates. The topographical mapping may be used to generate terrain models that accurately represent the terrain features. For example, one or more terrain models may include digital terrain models (DTM) that may include surface models (DSM) or digital elevation models (DEM) or similar that accurately represent course surfaces. The terrain models may be defined in a coordinate system corresponding, which may include transformable, to the coordinate system the course was mapped. The topographical mapping, terrain models, or combination thereof may be used to generate an accurate rending of the course surface and terrain features in a course visualization. For example, course models may be mapped in a Display coordinate system, accurate to scale, and include, for example, a surface DTM. Course models may comprise 3D digital models depicting terrain and into which graphics representing surface speed, paths, or other system generated data may be rendered to integrate data outputs of the various operations of the system 10 in course visualizations. Pin placements and course zones, e.g., fairways, greens, rough, hazards, tee boxes, among others, may be mapped and incorporated into models for processing, surface speed generation, visualization, or other operations of the system 10.

The tracking data processing system 30 may be configured to perform one or more processing operations with respect to the tracking data captured by the data collection system 20. Example processing operations include one or more of analyzing tracking data to extract path parameters for use in various system operations, filtering tracking data, smoothing tracking data, simulating paths utilizing path parameters extracted from the tracking data, reconstructing one or more portions of paths, identifying special cases, evaluating path quality, or determine whether to fall back to a simulated path for path generation applications. Filtering tracking data may include threshold filtering raw imaging sensor data. Threshold filtering may be used to filter out captured tracking data that may not be actual ball movements, e.g., misidentified object tracked, or that represent ball movements insufficient for use in the system 10, e.g., insufficient speed, number of points, time intervals between points, or combination thereof. Example threshold filtering may include utilizing speed threshold detection to identify actual putt movements. Speed threshold detection may be configurable to enable use under various conditions wherein determination of actual putt movements may be applicable to faster or slower speeds. In one example, a minimum speed threshold filter may be set at 10 inches/s or other suitable threshold determined to be suitable for the environment or other conditions. Threshold detection may include application of a time interval threshold filter that filters out coordinates timestamped at intervals greater than a minimum time interval. Threshold detection may include filtering tracking data by a minimum point count threshold for surface speed calculations. Smoothing tracking data may include one or more of temporal smoothing to reduce noise in tracking data or directional smoothing to ensure physically realistic ball paths. In one example, smoothing may utilize point windows. In a further example, window sizes may be adaptive.

Subsequent processing of tracking data may utilize filtered data, smoothed data, or both. In some embodiments, tracking data may not be filtered or smoothed, or subsequent processing of tracking data may not utilize filtered or smoothed data.

Analyzing tracking data to extract path parameters may include performing initial acceleration/deceleration calculations between or among points for used in filtering operations, such as removing paths having insufficient speed. Extracting path parameters may include determining metrics used in path smoothing operations. Extracting path parameters may include determining path parameters for use in simulations, e.g., as inputs to define simulations. In some embodiments, analyzing tracking data to extract path parameters may include analyzing tracking data to identifying incomplete paths. Incomplete paths may miss head portions, tail portions, or include other gaps in the path.

Identifying special cases may include analyzing paths to determine if the path represents a special case, such as a lip-out or holed putt with respect to a green surface. Respect to a fairway or other surface, lip-out identification may be used to detect when a ball path crosses a surface having different terrain features, such as a lip of a hazard, rough, course obstructions, or the like to enable the system 10 to handle the tracking data with respect to the encounter in a different manner with respect to surface speed, path generation, or both.

Simulating paths may include using path parameters such as initial launch parameters, starting and ending coordinates, and surface terrain to simulate the ball path. Paths may be simulated using physics-based simulations. Reconstructing one or more portions of paths may include simulating complete paths, portions of paths, or both to reconstruct incomplete paths, which may include simulated paths or actual paths captured by the imaging sensors. The actual paths may comprise those defined by raw data or one or both of filtered data or smoothed data. Simulated paths may be simulated from parameters derived from raw data, filtered data, smoothed data, or combination thereof. Reconstruction may include head reconstruction or tail reconstruction for incomplete paths. In various embodiments, a speed threshold multiplier may be applied to a simulation launch speed to identify a true beginning of a path captured in tracking data by filtering out pre-stroke noise, establishing a clean starting point for analysis. For instance, the tracking data processing system 30 may be configured to apply a speed threshold multiplier in a path detection or reconstruction operations. A speed threshold multiplier may be integrated as a parameter used in the path sanitization process. The speed threshold multiplier may be employed in identification of the start of a path. The speed threshold multiplier may be applied to a simulation's launch speed to create a threshold value. This threshold may be used to help determine when the actual putt begins in the raw tracking data. The tracking data processing system 30 may be configured to search for the first point where ball speed exceeds this threshold. The speed threshold multiplier may be used to filter noise and pre-path movement. For example, by using a percentage of the expected launch speed (e.g., 60% or a default value of 0.6), the tracking data processing system 30 can ignore small movements or noise in the tracking data before the actual putt or stroke begins. This helps eliminate false starts or pre-stroke adjustments that might be captured in the tracking data. The speed threshold multiplier may be used to create a clean starting point. For example, once a point exceeding the threshold is found, that becomes the starting point for the sanitized path. This may ensure analysis begins with the actual motion rather than noise. The parameter may be implements to achieve accurate putt analysis by helping establish a clean starting point for the putt trajectory, filtering out noise and irrelevant movements before the actual putt, and ensuring consistency in how putts are analyzed by standardizing the definition of when a putt begins. In one embodiment, the speed threshold multiplier may be set at a value of about 0.6. This value may be chosen to be high enough to exclude pre-putt noise but low enough to capture the true beginning of the putt stroke.

Evaluating path quality may include generating a base simulation and comparing the simulation with the captured path. Quality metrics with respect to the captured and simulated paths may be calculated, such as one or more metrics representative of the path quality compared to physic-based expectations such as average speed distance, maximum deviation, coverage percentages, e.g., with respect to distance, time, or both, or comparisons of quantification of how much curve is in the paths, e.g., path vs. direct distance ratio. One or more standards determinations, such as threshold determinations, may be applied to the quality measurements. These determinations may be used by the tracking data processing system 30 to determine whether to fall back to a simulated path for path generation applications. Path generation applications may include outputting paths or ball positions, which may include simulated paths, for comparison with scoring or other tracking operations. For example, path or position outputs may be compared with players shots, shot hit indications, starting position, ending position, or the like entered or collected by scoring or other tracking operation to confirm a hot characterization, or identify a mischaracterization. For instance, a shot hit may be entered or detected by a score tracking system. The shot hit indication may include a timestamp and one or more of a player, type of shot or zone location, a start coordinate (such as a shot end position entered or detected from a previous shot of the player), or in the hole. The timestamp and associated data may be compared with the path or parameters derived therefrom to confirm the shot hit indication is consistent with the path or parameters. In instances when the comparison indicates inconsistencies, the event may be flagged for personnel to review to resolve the inconsistency. This may be used to ensure accuracy across tracking systems, which may be particularly beneficial when the score or other tracking system, like system 10, is configured to execute in an automated environment without human intervention to perform its base operations. In various embodiments, only actual path data captured by imaging sensors 22, which may include filtered data, smoothed data, or both, is used by the surface speed processor 40 to calculate surface speeds.

In various embodiments, the tracking data processing system 30 may be configured to output actual captured path, actual captured path including one or more portions reconstructed using simulation data, a pure simulation path, or error, e.g., due to insufficient, erratic, or otherwise aberrant data.

The surface speed processor 40 may utilize paths represented in the tracking data, e.g., sequential coordinates with time stamps, to generate surface speeds with respect to points in the path. The surface speeds for the points correspond to the surface speed of the position on the surface the point is located, which may include path segments in which the point is linked. In various embodiments, the surface speed processor 40 is configured to perform deceleration analysis with respect to the points, and isolate slope effect to generate a friction coefficient. In one embodiment, isolation of slope effect includes calculation of slope angle between consecutive points using terrain data, e.g., DTM data, calculation of elevation-related acceleration components, isolation of pure friction component by removing slope effects, and conversion of friction deceleration to friction coefficient. In one example, the friction coefficient is converted to a surface speed unit, such as stimp, using a physics-based conversion factor. In some embodiments, window weighting may be used to weight surface speed or parameters incorporated therein with those of one or more flanking points or segments. For example, deceleration analysis may include a window-based analysis of ball deceleration including calculation of total deceleration from polynomial fitting of position-time data. In another example, weighted averaging with respect to surface speed calculations may be applied across multiple points. In various embodiments, the surface speed processor 40 is configured with adaptive window weighting capabilities.

The surface speed processor may be configured to generate surface speeds with respect to points on the surface corresponding to ball paths, collect these measurements from multiple paths, geospatially position each measurement with respect to the mapped surface to correlate the surface speeds with terrain features. In various embodiments, the surface speed processor 40 is configured to execute surface interpolation operations to generate a continuous surface speed surface. In one example, grid-based sampling may be utilized for interpolation. In a further example, sparse matrix interpolation may be used to generate the continuous stimp surface.

As introduced above, the system 10 may include or be configured to execute operations described herein with respect to visualization system 60. For example, surface speed outputs of the surface speed processor 40 by utilized by a visualization system 60 to generate visualization data for rendering a surface speed visualization 82 (see FIG. 4). The surface speed visualization 82 may include graphical representations of surface speed rendered onto a representation of the surface it corresponds. For example, the visualization system 60 may be configured to render or generate visualization data for rendering of a graphical representation of surface speed onto a surface visualization representing the green surface the surface speeds relate, which may also be referred to herein as a course visualization. The surface speed visualization 82 may be provided in any suitable graphical form, which may include digital 2D or 3D environments, ground overlays, extended reality displays (augmented reality, virtual reality, which may be 360 degree immersion, or mixed reality), as examples. Example surface views may comprise or be rendered from 2D or 3D models or image data. Surface views or surface speed visualizations 82 may depict terrain. Surface views or surface speed visualizations 82 may comprise GIS data. In some embodiments, surface speed visualizations 82 may be rendered such that they are navigable to provide views of the surface from multiple perspectives. In one example, as point of view changes, the surface view adjusts to a reality scale or preset scale corresponding to the distance of the point of view. In one embodiment, surface speed visualizations 82 include a heatmap rendering onto graphical a representation of the surface to represent a range of surface speeds across the surface.

The visualization system may generate various visualizations or data for rendering visualizations of ball paths, surface speed, or both. Visualizations may implement rendering schemes using surface speed data and course GIS data, which may include course models, e.g., 3D digital models. In some embodiments, the visualization system 60 may be configured to output visualizations or visualization data for rendering visualizations of ball paths. The paths may comprise actual paths captured by image data, simulated paths, reconstructed paths, or combination thereof.

The system may include or be configured to utilize operations of a coordinate transformation infrastructure comprising a coordinate translator 70. The coordinate translator 70 may be configured to enable integration of operations with respect to transformation of coordinate operations between coordinate systems. For example, data collection operations may collect position coordinates in a different coordinate system than is utilized for performing various calculation operations with respect to paths, surface speeds, or both. The coordinate transformation infrastructure may enable integration of captured tracking data with course topology data, e.g., with respect to one or more DTMs, course models employed for course visualization, or combination thereof. Additionally or alternatively, one or more of the above operations or other operations of the system 10 may be performed with respect to a coordinate system different than that used for visualizations, such as visualizations generated by the visualization system. Thus, the system 10 may be configured to perform operations in one or more coordinate systems, transform or obtain transformed coordinates between coordinate systems, or combination thereof. In one embodiment, tracking data may be collected in first coordinate system, e.g., a global coordinate system. One or more calculations with respect to paths or related path parameters may be performed with respect to the first coordinate system or a second coordinate system. For example, captured position coordinates or path parameters derived therefrom may be transformed from the first coordinate system for application of processing, e.g., surface speed calculations, in the second coordinate system. In this or another example, visualizations with respect to stimp may be displayed in a third coordinate system such that the coordinates with respect to paths and stimp calculations derived therefrom may be accurately displayed with respect to the course in a manner corresponding to the course in a course visualization. In one example, the first coordinate system comprises a Map coordinate system, the second coordinate system comprises an Application coordinate system, and the third coordinate system comprises a Display coordinate system. As noted above, few, additional, or different coordinate systems may be used.

Outputs of the system 10 may be provided in any suitable coordinate system. For example, the coordinate translator 70 may be employed to translate outputs to a desired coordinate system, if needed. The system 10 may output ball path or surface speed data in various formats, which may include customized formats, suitable for the end use application. The outputs may include course models in which to render paths or surface speed. In some embodiments, outputs are provided in data not formatted for direct visualization applications. For example, outputs may include path coordinate data and timestamps that may be used for various applications, such as one or more of prediction, scoring, or tracking operations, which may include statistics collection. In one embodiment, outputs are provided with course visualization models or reference to course visualization models for rendering visualizations of the outputs. In one embodiment, course visualizations are streamed or output for server-side rendering, client-side rendering, or combination thereof.

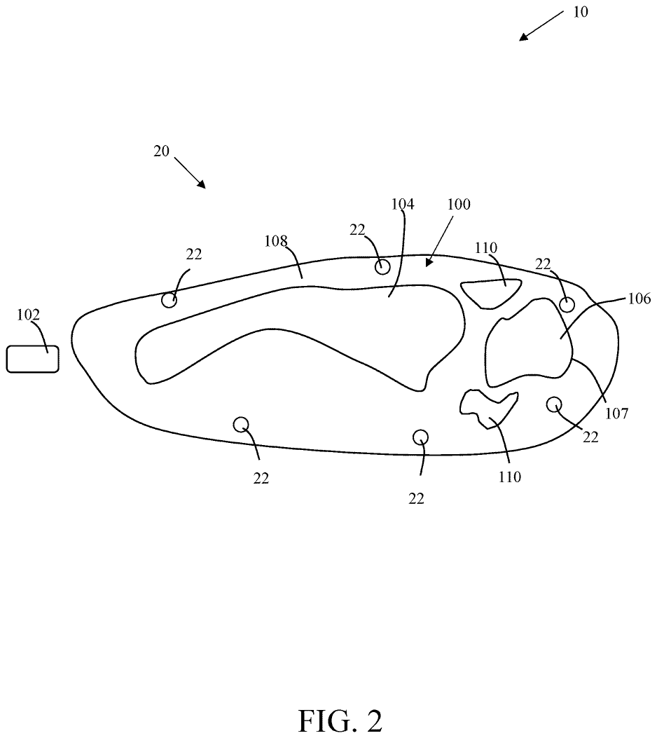

FIG. 2 depicts an example data collection system 20 with one or more imaging sensors 22 configured to capture tracking data by tracking ball paths along surfaces and recording precise ball positions and corresponding timestamps. For example, imaging sensors 22 or data collection system 20 may be configured with computer vision to detect players and postures to identify putting or hitting positions or track putting or hitting motion to assist in identification of actual putts. This may be used in sanitization operations to validate tracking data as actual ball hit, in scoring operations to link stroke or stroke time to a player or player known to be taking a stroke or indicated to be taking a stroke, as examples. In some embodiments, tracking data is transmitted from the imaging sensors 22 to one or more local or remote processors for path coordinate identification and timestamp association.

Imaging sensors 22 may be employed for various tracking tasks, such as tracking players, golf balls, or other objects. The data collection system 20 may comprise tracking logic with respect to one or more of recognition, detection, computer vision, or other image analysis operations. In one example, machine learning for optical recognition, computer vision, object detection, or combination thereof may be employed. For instance, the data collection system 20 may employ facial recognition, body recognition, gait recognition, clothing recognition, ball/shape recognition, or the like with respect to camera data to identify participants and/or balls, pair location with player or player ball, or both. In some embodiments, players may carry or wear an optical, electromagnetic, or reflective maker identifiable by imaging sensors 22 or other component of the data collection system 20 that uniquely identifies the player. In these or other embodiments, imaging sensors 22 may utilize optical recognition/augmented reality (AR) to locate players and/or balls. Imaging sensors 22 or data collection system 20 may be configured with computer vision to detect players and postures to identify putting or hitting positions or track putting or hitting motion to assist in identification of actual putts. This may be used in sanitization operations to validate tracking data as actual ball hit, in scoring operations to link stroke or stroke time to a player or player known to be taking a stroke or indicated to be taking a stroke, as examples. In some embodiments, tracking data is transmitted from the imaging sensors 22 to one or more local or remote processors for path coordinate identification and timestamp association.

The illustrated data collection system 10 includes a plurality of imaging sensors 22 positioned around a hole 100. The hole 100 includes a tee box 102, fairway 104, green 106 (a green boundary 107 is also depicted), rough 108, and hazards 110. The imaging sensors 22 each have a field of view to detect and track balls moving along surfaces of the hole 100. Imaging sensors 22 may be positioned at elevated locations with respect to the surface tracked to capture ball paths within its field of view. Imaging sensors 22 may be set with fixed fields of view or may be configured to have multiple fields of view e.g., movable via powered gearing, which may include or incorporate autonomous/auto-tracking robotics, to change field of view. Imaging sensors 22 may be located at known locations, but in some instances one or more imaging sensors 22 may be utilized in a mobile environment, e.g., utilizing real-time kinematics (RTK). In one example, one or more imaging sensors 22 may be mounted to a drone that captures images for path tracking operations to identify position coordinates and provide corresponding timestamps. As noted above, imaging sensors 22 or data collection system 20 may be calibrated to a coordinate system to accurate identify tracked positions with coordinates. The data collection system 20 may utilize the location of the imaging sensor 22 to calibrate the imaging sensor 22, e.g., calibrate the field of view to mapped coordinates for use in the tracking operations. In one example, the field of view may be layered over a course map, e.g., a LIDAR point cloud, 3D course model, coordinate map, or combination thereof, to calibrate the imaging sensor 22. For instance, anchor points in a course map may be aligned with the corresponding anchor points present in the field of view. As also noted above, the system 10 may include or incorporate operations of a coordinate translator 70 to translate coordinates between coordinate systems use by the various systems and components thereof.

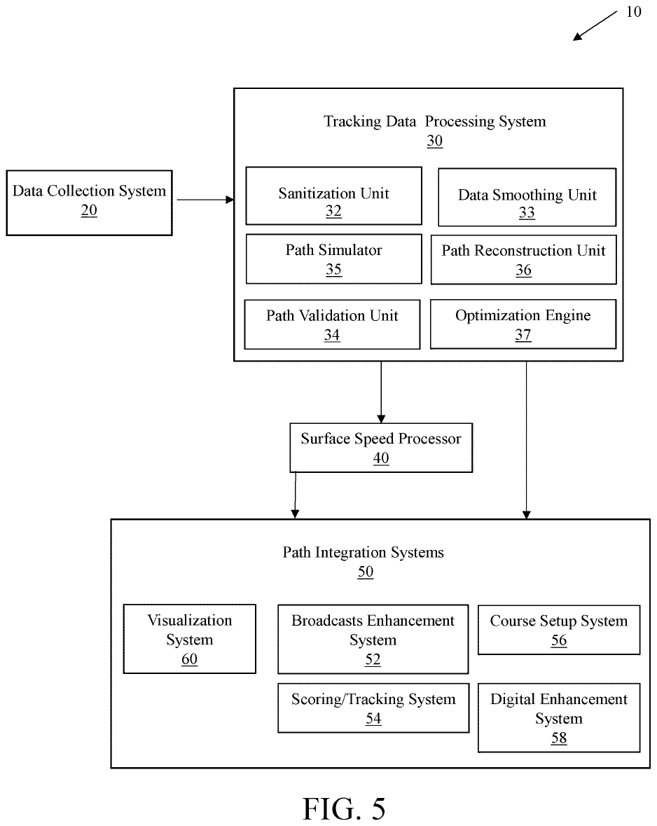

In some embodiments, multiple imaging sensors 22 may have or be positionable to have overlapping fields of view to capture ball movement in a same area. This may be used to improve data quality by ensuring tracks may be captured from multiple perspectives or locations. For instance, a field of view of one imaging sensor 22 may be obstructed with respect to all or a portion of a path, e.g., a player may obstruct the field of view. In another example, one imaging sensor may be out of position to track the path because it changed its field of view to track the path of another object. Thus, with multiple tracked paths, system 10 or data collection system 20 may compare the paths to select the most complete path, path most consistent with an expected path based on a physics simulation incorporating terrain and detected speed parameters and one or more coordinate points, path with the lease amount of noise, or other aspect. In some embodiments, processing techniques may be used to combine the tracking data by excluding erratic or aberrant portions of a path inconsistent with an expected path or a captured path. In one example, captured paths may be stitched or a portion of one path may be otherwise combined to another path to fill a gap, which may be referred to as path reconstruction. As noted elsewhere herein, in some embodiments, paths may be simulated, e.g., using a path simulator 35 (see FIG. 5). In various embodiments, path simulations may be used to reconstruct one or more portions of a path.

Ball paths include consecutive path points (coordinates) representing the path of the ball and position at each timestamp. Consecutive points may be connected by line segments. For instance, the path may be represented as an ordered sequence of coordinate points, and each segment comprises to adjacent points in this sequence. Each segment, therefore, is representative of movement between two consecutive recorded positions.

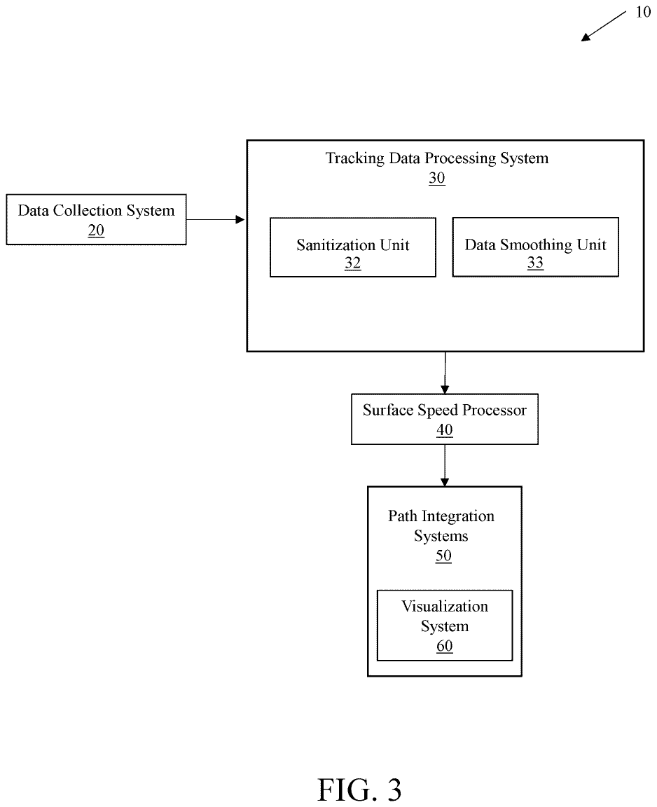

FIG. 3 schematically illustrates features of the tracking data processing system 30 according to various embodiments. The system 10 may be configured to perform, integrate, or provide one or more of the data collection, surface speed, visualization, or other path integration systems 50, or combination thereof as described above with respect to FIGS. 1 & 2. The tracking data processing system 30 may be configured to perform path sanitization processing, e.g., utilizing a path sanitization unit 32, comprising filtering raw imaging sensor data to identify valid ball movements. In one example, this may include application of speed thresholds, time thresholds, or both. For example, path sanitization may include application of speed thresholds and time interval filtering. The tracking data processing system 30 may analyze coordinates and associated timestamps to determine speed, acceleration, deceleration, between or among points. Speed threshold detection may be employed to identify actual ball movements. For example, speed threshold detection may be employed to identify actual putt movements. In an example application for use to calculate green speed, an example minimum speed threshold may be 10 inches/s. Time interval filtering may be set based on desired resolution. In one example, time interval filtering may be set at less than 125 milliseconds. Additionally or alternatively, path sanitization may include application of movement thresholds to ensure paths are consistent with physics-based expectations of movement utilizing position coordinates and time may be applied to filter out erratic or other aberrant tracking data inconsistent with physics principles. Additionally or alternatively, the tracking data processor 30 may apply a minimum number of points threshold. For example, a path may be analyzed to ensure it has minimum number of points suitable for surface speed calculations. Minimum points may be set based on sufficiency for use in surface speed, path, or other operations of the system 10. For example, minimum point counts may be set to 3 when 2 points is not enough data to calculate surface speed.

In some embodiments, tracking data not meeting one or more thresholds may be deemed unsuitable for surface speed calculations. This incomplete or aberrant tracking data may be disregarded. In another example, incomplete or aberrant paths may be retained for use in path generation in other applications, which may include actual (observed path captured by the data collection system), simulated, reconstructed paths, or combination thereof.

The tracking data processing system 30 may be configured to perform path smoothing processing, e.g., utilizing a path smoothing unit 33. Path smoothing may include various types of smoothing. For example, tracking data may be temporally smoothed, directionally smoothed, or both. Temporal smoothing may be employed to reduce noise in tracking data. Directional smoothing may be used to, for example, ensure physically realistic ball paths, which may be in addition to filtering to ensure ball paths conform to physics principles described above with respect to sanitization processing. Temporal or directional smoothing may be performed by smoothing methods known in the art.

In various embodiments, the tracking data processing system 30 is configured to perform temporal smoothing utilizing a “flip-flop” detection and correction approach that identifies points with maximum flip-flop deviations by examining a window of points in a path. The smoothing may specifically target temporal inconsistencies in ball movement by identifying physically unrealistic acceleration patterns in the tracking data. In one example of the flip-flop detection and correction approach, the tracking data processing system 30, e.g., the data smoothing unit 33, is configured to identifies points with maximum flip-flop deviation by examining 5-point windows in a path provided in the tracking data, current point plus 2 points before and 2 points after. For each window, segment distance differences are calculated between consecutive points (d1, d2, d3, d4). The average difference may be calculated and deviations from the average identified. A “flip-flop” pattern may be detected when consecutive deviations have opposite signs, which indicate unrealistic acceleration changes. The point with the highest flip-flop score, as the sum of absolute deviations, may be adjusted. Adjustment correspond to repositioning the point based on a weighted average of the expected distance, based on average difference, and current distance. Adjusted metrics may be recalculated after adjustment and the process may be repeated for a specified number of smoothing attempts or until no significant deviations remain. In one example, recalculated metrics include distances, speeds, and accelerations.

In various embodiments, the tracking data processing system 30 is configured to perform directional smoothing that focuses on angle changes. For example, the tracking data processing system 30, e.g., the data smoothing unit 33, may identify points with maximum path direction deviation by examining angle changes between consecutive segments. This may include identifying angle changes exceeding a threshold that represent unrealistic direction changes. For instance, the threshold may be set to 0.1 radians. When such a point is found, the position may be adjusted by calculating the expected angle based on the angle of the previous segment and angle change trend, maintaining the same or approximately the same distance from the previous point, and repositioning the point along this expected angle. After adjustment, metrics including segment angles and angle changes may be recalculated and the process repeats for a specified number of iterations or until no significant direction deviations remain. This smoothing process may be used to ensure the ball path follows physically realistic trajectories without abrupt direction changes that would be impossible in real ball physics. The tracking data processing system may utilize adaptive window sizes in path smoothing operations. Thus, the window sizes may be adapted to achieve desired smoothing.

In various embodiments, processing of tracking data by the tracking data processing system 30 with respect to one or more of simulations, reconstructions, path validation, or optimization, surface speed generation, or combination thereof utilize smoothed tracking data or that has otherwise been subjected to one or more path smoothing processes. In some embodiments, path sanitization, data smoothing, or both, are not performed or may be optional.

FIG. 4 schematically illustrates features of a surface speed processor 40 and visualization system 60 of a golf data collection and management system 10 according to various embodiments. The surface speed processor 40 may ingest tracking data with respect to captured ball paths. In one example, the ball paths are captured as described herein, such as with respect to FIGS. 1 & 2. In this or another example, the tracking data may be one or both of filtered or smoothed, which may in a manner similar to that described with respect to FIG. 1 or 3. While filtered data, smoothed data, or both may be used to improve internal processing and outputs, in some embodiments, raw data may be used. The surface speed processor 40 may be configured to analyze paths and generate surface speed calculations. Surface speed calculations may include performing a deceleration analysis including calculation of total deceleration, calculating slope angle between consecutive points using terrain data, calculating elevation-related acceleration components, isolation of pure friction component by removing slope effects, and converting friction deceleration to friction coefficient. The friction coefficient may then be converted to the desired surface speed unit. In various embodiments, total deceleration is calculated from polynomial fitting of position-time data.

In some embodiments, weighted averaging may be applied across multiple points. For example, weighted averaging may be applied in a two-level system for smoothing and adaptive window weighting, where weights are applied within each window calculation of points and combines multiple window-based surface speed values that include a particular point.

In various embodiments, deceleration analysis includes window-based analysis of ball deceleration using a window including a number of points. The size of the window may be adaptive and set as desired with respect to different paths or points within a path. For brevity, a 4-point window is generally referenced herein. In one example, calculation of slope angle between consecutive points using terrain data. For example, DTM data may be used to calculate the slope angle between points. For example, if necessary, ball position coordinates may be translated between coordinate systems from one coordinate system to another. Bilinear interpolation may be used to retrieve elevation (Z) values at the points. Horizontal distance between points may be calculated and the height distance between points may be determined. The slope angle may be calculated using arctangent of (height difference/horizontal distance). In an example, calculation of elevation-related acceleration components comprises the formula (g×sin(θ)). For instance, the surface speed processor 40 may be configured to calculate the acceleration component due to slope using the formula (−g*sin (slope angle)), where g is the gravitational constant (386.4 inches/s²), slope angle is the angle calculated from the terrain data, and the negative sign ensures proper directional effect (negative for uphill, positive for downhill). In an example, the surface speed processor 40 may be configured to isolate the pure friction component by subtracting the slope-induced acceleration from the total measured deceleration. Thus, due to implementation of this separation, total deceleration includes both friction and slope effects. By removing the slope component, deceleration due to the surface friction is obtained. In an example, the surface speed processor 40 may be configured to convert the isolated friction deceleration into a friction coefficient using the formula (-friction acceleration)/(g*cos (slope angle)), where the negative sign converts deceleration to a positive coefficient. Division by (g*cos (slope angle)) accounts for the normal force component. In an example, the surface speed processor 40 may be configured to apply a physics-based conversion factor for a surface speed unit to the friction coefficient. For instance, a stimp conversion factor of 0.559 may be divided by the friction coefficient to obtain a surface speed value. In an example, the surface speed processor 40 may be configured to apply weighted averaging across multiple points for stability and adaptive window weighting. For instance, predefined weights for common window sizes (e.g., [0.1, 0.4, 0.4, 0.1] for a 4-point window) may be used, and the surface speed processor 40 may dynamically generate weights for other window sizes that are higher in the middle and lower at the edges, and ensure all weights sum to 1.0 through normalization. The surface speed processor 40 may then apply these weights when combining surface speed values from multiple calculations, as described herein.

In various embodiments, the surface speed processor 40 is configured to execute a method that generates surface speed with respect to a path. A sequence of ball position points with timestamps may be identified or otherwise used that defines the path. The method may include calculating total deceleration from position data using polynomial fitting. The fitting formula may include position=a+b*t+c*t²; acceleration=2*c*12 (inches/s 2), where t represents time (relative to the start of the window), a, b, and c are fitted coefficients in the quadratic equation position=a+b*t+c*t², a represents the initial position, b represents the initial velocity, and c represents half the acceleration (acceleration=2c). The fitting may be performed across multiple positions in a window, e.g., 4 points, to obtain a smooth acceleration value. The size of the window may be adaptive. While acceleration could be calculated between individual point pairs, noise may be reduced by takes a sequence of position-time data points, fitting a quadratic polynomial to the sequence, extracting the acceleration term (2c) from this polynomial, and associating this acceleration with the entire window rather than individual points.

The method may include calculating a slope component: (−g*sin (slope angle)), extracting a friction component: (total deceleration−slope component), calculating a friction coefficient: (−friction acceleration/(g*cos (slope angle))), converting to a surface speed unit: (surface speed conversion factor/friction coefficient), and applying weighted averaging across multiple points. In one example, the surface speed unit comprises stimp, and converting to the stimp unit comprises calculating: (0.559/friction coefficient). The stimp conversion factor may be derived from physics-based calculation of a golf ball released from a stimp meter wherein Initial velocity (v₀)=6 ft/s, using stimp value of 12 ft (distance rolled), and standard gravity (g)=32.2 ft/s². The relationship between distance, initial velocity, and deceleration: d=V₀²/(2a), where a is the deceleration due to friction. For stimp=12 ft: 12=36/(2a), a=1.5 ft/s². The coefficient of friction (μ) is: μ=a/g=1.5/32.2=0.0466, and stimp conversion factor is 12×0.0466=0.559.

According to this methodology, the slope component calculation inherently accounts for the direction of the slope relative to the path of the ball because slope is calculated along the actual path the ball traveled, start and end points of each window are used to determine the direction vector, and elevation difference is measured along this path. This ensures the slope component reflects the actual uphill/downhill component the ball experienced. The surface speed processor 40 may be configured to calculate slope angles at each measurement point and use these slope angles to separate the effects of gravity (slope) from the effects of friction (surface speed) in the ball's deceleration. This allows for accurate surface speed measurements even on sloped surfaces.

Window based analysis may create overlapping windows of consecutive points. For each valid window, a surface speed value is calculated. The window is then slide forward by one point and the calculation of surface speed value is repeated for the new overlapping window. Thus, each point, except those at the edges, participates in multiple windows. In various embodiments, the methodology may stop processing windows once it reaches a point with speed below a defined threshold, e.g., 10 inches/s.

Weighted averaging may correspond to both surface speed smoothing and adaptive window weighting. For instance, this two-level weighting system may first apply weights within each window calculation, e.g., [0.1, 0.4, 0.4, 0.1] weights, and then combine multiple window-based surface speed values that include a particular point. Application of weighting across multiple points may include grouping points into overlapping windows, e.g., 4 consecutive points per window. A surface speed calculation may be made for each window as a whole. This surface speed value may then be attributed to all points in that window, but with different weights. Each point accumulates weighted surface speed values from all windows in which it participates. Each point may be assigned a weighted or final value such that the value is the weighted average of these contributions. Point groupings may be determined by sequential order along the path.

Weights are typically determined to be higher with respect to points more proximate such that weights in the center of the window are more than those on the outside. For example, using predefined weights [0.1, 0.4, 0.4, 0.1] provides a nice approximation to weight the center more than the outside. In some embodiments, other window sizes may be used. Weights for various window sizes may be determined using a triangular distribution. For example, for each position i in the window, the distance to the midpoint may be calculated: |i−midpoint|. Weight may be set to 1.0−(distance/window size). Weights may then be normalized to sum to 1.0. This creates a weight distribution that emphasizes the middle points and de-emphasizes edge points. This weighting scheme may be employed to reduce noise and produces more stable surface speed values.

In various embodiments, the surface speed processor 40 may include a spatial analysis unit 42. The spatial analysis unit 42 may be configured to process surface speed measurements generated for multiple paths. For example, the spatial analysis unit 42 may implement geospatial positioning of surface speed measurements that correlates with terrain features, such as slopes, grain direction, green boundaries, or the like. For example, the spatial analysis unit 42 may maps surface speed measurements to their precise locations on the surface. Each surface speed measurement may be associated with specific coordinates in both Map and Application coordinate systems. The coordinate translator 70 may transform the coordinates between different spaces as needed for analysis and visualization. Association of surface speed measurements with mapped coordinates, correlates the measurements to the terrain features.

In various embodiments, the spatial analysis unit 42 is configured to generate a continuous surface speed across the surface from multiple paths. This may include combining measured surface speed values within a defined area, e.g., grid coordinate, of the surface, performing estimations of surface speed in defined areas that do not have or have limited surface speed values, or the like. For instance, in various embodiments, the spatial analysis unit 42 is configured to interpolate surface speed values to generate a continuous surface speed values. In one example, the spatial analysis unit 42 is configured to perform a sparse matrix interpolation to generate continuous stimp surface. Sparse matrix interpolation encompasses a family of techniques that address the problem of estimating missing values in sparse data structures. Those having skill in the art will appreciate upon reading the present disclosure that alternative interpolation methods know in the art may be, e.g., Kriging (geostatistical method), inverse distance weighting, radial basis functions, triangulated irregular network (TIN), polynomial interpolation, among others. In some embodiments, the spatial analysis unit 42 may be configured to extrapolate surface speeds using understood extrapolation techniques.

As noted above, the spatial analysis unit 42 may utilize grid-based sampling across surfaces. Grid-based sampling may be implemented as part of the interpolation process. The defined areas or coordinate of the grid will typically be uniform; however, nonuniform grid areas could be employed. Grid-based sampling may be implemented as part of an overall interpolation process. The spatial analysis unit 42 may include definable grid sizes, such as a grid with regular intervals, e.g., grid interval=12 inches, and be configured to sample the interpolated surface speed values at these grid points.

Surface speed values closer to a coordinate of interest may be weighted more than values farther from the coordinate of interest. Multiple surface speed points may be handled through the interpolation process. For example, the sparse matrix interpolation weights nearby measurements based on distance, creating a smoothed surface. In various embodiments, the sparse matrix interpolation processing may be swapped out with any of the many other possible interpolation routines for 2D data. In various embodiments, the surface speed calculations may be dynamically updated during play in near real-time. In some embodiments, multiple points having surface speed values within a grid coordinate area may be weighted such that points corresponding to paths more recent in time may be given greater weight.

In some embodiments, the spatial analysis unit 42 may be configured to verify that points fall within mapped surface boundaries by comparing the points to the boundaries of the mapped surface. For instance, a surface comprising a green may be mapped wherein the map specifies boundaries of the green. The spatial analysis unit 42 may correlate coordinates of the points to the boundaries to check if the points fall within the boundaries. If they do not, the spatial analysis unit 42 may exclude the points outside the boundaries, exclude the entire path, output a notification for administrator review of the discrepancy, or combination thereof. If points fall within the boundaries, the spatial analysis unit 42 may include the points in the final dataset. In one example, the spatial analysis unit 42 uses its Application coordinate system to check if points are within defined boundaries. Boundary verification may typically be performed on the grid points generated after interpolation, rather than specific path points. For example, with respect to a green surface the spatial analysis unit 42 may check if each grid point falls within the green boundary before including it in the visualization data, e.g., a final heatmap. However, in one embodiment, the spatial analysis unit 42 may analyze path points to verify location within boundaries.

The spatial analysis unit 42 may be configured with one or more resolution management aspects for computational efficiency. For example, resolution management may be implemented through one or more parameters. Definable grid interval settings, e.g., grid interval=12 inches, may be employed to control the density of sampling points. Definable interpolation parameters, such as interval: 36*6, may be provided to control the interpolation neighborhood size. Definable controls for controlling point density, e.g., decimation interval: grid interval, may additionally or alternatively be provided with respect to resolution management. The spatial analysis unit 42 may enable user selection of different intervals.

The visualization system 60 is configured to generate visualization data that when rendered provide a visualization of surface speed 82 in a display 80. The visualization system 60 may include a surface speed mapping unit 62 configured to map the surface speed outputs to accurately represent the surface speeds relative to the surface and terrain to which they correspond. The surface speed mapping unit may be configured to generate visualization data for rendering to a graphical representation of the surface on a display 82 wherein the visualization data causes integration of the surface speeds or graphical indica thereof a positions along the surface and terrain to which they correspond.

In some embodiments, the surface speed mapping unit 62 may utilize coordinate translator 70 (see, e.g., FIG. 1) to transform coordinates for rendering of the surface speed graphics to a course model. In some embodiments, visualization system 60 is configured to render the visualization data to provide surface speed graphics within representative course models. In these or other embodiments, the visualization system 60 generates visualization data for transmission to one or more path integration systems 50 or client systems wherein the path integration systems 50 or client systems transform the coordinates to suitable Display coordinates for rendering in course models.

The surface speed mapping unit 62 may integrate the surface speeds calculated from tracking data into a course visualization. The surface may be provided in a course visualization, such as any of those described herein, e.g., a 3D representation, of the surface. In one example, surface speed values or indicia may be rendered onto a graphical representation of the surface. The surface speed values may be provided numerically. In one example, the visualization comprises a heatmap or other color gradient mapping based on the calculated surface speed value ranges. For example, a typical visualization range for stimp green speed of a professional golf tournament is between 10 (slow) to 15 (fast). Green speeds within this range may be represented in a color progression, e.g., Magenta→Purple→Blue→White→Yellow→Orange→Red. In one example, rendering of the visualization data renders spheres at grid points with color-coded stimp values. Other visual depictions of surface speed may additionally or alternatively be generated. For example, surface speeds may be provided in bulls eye map format.

In one embodiment, the visualization system 60 is configured to provide visualizations, generate visualizations, or both of paths relative to the surface. The visualization system 60 may provide visualizations of calculated surface speeds or other calculated data with respect to individual paths. For example, graphical displays that depict surface speed over time, surface speed relative to elevation or elevation change over time, speed over time, speed relative to elevation, acceleration, or deceleration between segments, or other.

As introduced above, the system 10 may include coordinate translator 70 configured to perform translations between coordinate systems for system operations, when so configured, or as desired for formatting outputs. For example, surface speed calculations may be performed in coordinates converted to Application coordinates, using DTM data in the Application space. In one embodiment, one or more surface speed calculations, which may include one or more of interpolation or integration for visualizations, are made from coordinate transformations from Map to Application, and Application to Display for visualizations of surface speed. In some embodiments, surface speed visualization data may be output with respect to another coordinate system and transformed, if needed, for integration in a particular path integration system. For example, surface speed visualization data may be converted from App to Map or another coordinate system for output.

FIG. 5 schematically illustrates various features of a tracking data processing system 30 of a golf data collection and management system 10 according to various embodiments. In some embodiments, the data collection system 20, surface speed processor 40, visualization system 60, or other components or operations of the system 10 may be similar to those described with respect to FIGS. 1-4.

The tracking data processing system 30 may include a path simulator 35. The path simulator 35 may be utilized to generate path simulations. The path simulator 35 may implements physics models for ball movement, including friction, gravity, and terrain effects. For example, parameters integrated into simulations may include captured start/end points, terrain data, e.g., elevation data obtained for DTM, and launch parameters such as speed and direction angle. In various embodiments, the path simulator 35 may not directly extract friction coefficients from captured paths, but may use the surface speed value as a proxy for friction characteristics of the surface. For instance, simulation parameters may include surface speed values. In one example, a default surface speed value is set, e.g., 12 stimp, but is adjustable in simulation operations to assist in accurate simulation in comparison to captured path. Simulations may also incorporate simulated timestamps. The timestamps may correspond to the time stamp interval of captured path. In one example, simulation timestamp interval may include points that correspond to all or some of the points in the captured path. An example, simulation timestamp interval may be 0.05 seconds.

In various embodiments, when the tracking data processing system 30 determines path data is complete, the tracking data processing system 30 may be configured to perform path reconstruction operations, e.g., utilizing path reconstruction unit 36. In some embodiments, tracking data may be determined to be incomplete in sanitization processing. For instance, the sanitization unit 32 may identify valid tracking data by finding a start index where ball speed exceeds a threshold (relative to simulation launch speed), continuing until speed drops below a minimum threshold, and checking if there are enough points (e.g., greater than 3) after sanitization. For instance, the tracking data processing system 30 may be configured to apply a speed threshold multiplier as a parameter in the path sanitization process. The speed threshold multiplier may be employed to identify the start of a path. For example, the speed threshold multiplier may be applied to a simulation's launch speed to create a threshold value. This threshold may be used to help determine when the actual putt begins in the raw tracking data. The tracking data processing system 30 may be configured to search for the first point where ball speed exceeds this threshold. The speed threshold multiplier may be used to filter noise and pre-path movement. For example, by using a percentage of the expected launch speed (e.g., 60% or a default value of 0.6), the tracking data processing system 30 can ignore small movements or noise in the tracking data before the actual putt or stroke begins and create a clean starting point. For example, once a point exceeding the threshold is found, that point set as the start index, becoming the starting point for the sanitized path. The path evaluation unit 34 may evaluate data quality by checking if sanitization was successful, e.g., the data is appended with a sanitization success flag or other indication, evaluating path vs. direct distance ratio (e.g., greater than 1.2 may be set to indicate abnormal data). In any of the above or another embodiment, distance-based detection may be used to detect missing head data by comparing the first path point to an expected shot origin. In any of the above or another embodiment, holed putt detection may be used for detection of putts that went in the hole. For instance, the tracking data processing system 30 may be configured to assume tail data is incomplete since the ball disappears into the hole.

Reconstruction may utilize simulation modeling. For instance, the path simulator 35 may generate a baseline physics simulation in a manner described above using parameters such as captured start/end points, terrain data, and launch parameters. For holed putts, the path reconstruction unit 36 may utilize multiple simulations to optimize the simulation to match captured path data. For lip-outs, the path reconstruction unit 36 may utilize an approach to match the simulation to pre-lip-out portion of the path.

In various embodiments, reconstruction may be specifically targeted at the heads and tails of path. In one example, head reconstruction is performed when a first camera point is significantly distant from the shot start position or origin. The path reconstruction unit 36 may be configured to use simulation data generated by the path simulator 35 to reconstruct the path from the shot origin to the first camera point. In one example, the path reconstruction unit 36 may be configured to further rotate simulation points for reconstruction to align with the tracking data of the captured path direction. The path reconstruction unit 36 may be configured to reconstruct tail portions of paths for putts determined to go into the hole. This may include using simulation data to extend the path from a last captured path point to the hole location. The simulation data may be generated by the path simulator 35 using physics simulation to create a realistic path into the hole, which may be in a manner described above and elsewhere herein.

In various embodiments, the tracking data processing system 30 is configured to perform optimizations to optimize path parameters, which may be used to generate an optimized path for use in optimization of simulations, reconstruction of one or more portions of a path, or combination thereof. For example, path reconstruction unit 36 may use operations of path simulator 35 and optimization engine 37 to generate optimized paths for use in reconstruction operations. In some embodiments, optimization may include creating a baseline simulation, which may be used as a base reference simulation. Simulation parameters may be optimized to better match the path captured in the tracking data, e.g., coordinate positions over time. The simulation including the optimized parameters may be utilized for path reconstruction. In one example, optimization may include sanitizing the tracking data with respect to the path. Parameters optimized may include launch speed. Ball path trajectory may be indirectly optimized as well. In some embodiments, optimization is performed to find the launch speed that produces a simulation with the closest speed profile to the observed path captured in the tracking data, while maintaining the physical constraints of the terrain and the known start/end points. For example, for holed putts, the optimization increases speed to find a simulation where the ball would have enough momentum to reach and fall into the hole. The optimization may include creating a baseline simulation, which may be used as a base reference simulation. Launch speed may be iteratively increased by small increments, e.g., 0.5-1% per increment. For each speed, the path simulator 35 may run a simulation. A match score may then be calculated based on how well the simulation's speed profile matches the captured path in the tracking data. The tracking data processing system 30 may select the simulation with the best match score and use this optimized simulation for tail reconstruction. Similar optimization operations may be performed with respect to lip-outs. In one example, for lip-outs, the optimization engine 37 uses only the camera data up to the lip-out point for matching.

The tracking data processing system 30 may be configured to detect special cases with respect to putts. In some embodiments, special case detection with respect to holed putts, lip-outs, or both causes the data processing system 30 to optimize parameters to generate an optimized path for use in path reconstruction. In one example, how the tracking data processing system 30 optimizes the simulation and reconstructs the complete path to ensure more accurate representation of these complex putting scenarios may be influenced by the particular special case detected. For instance, the tracking data processing system 30 may be configured to detect holed putts. Holed putt detection may include detection of path end coordinates corresponding to the pin/hole or approximate thereto, analysis of speed deceleration at the end of the path that is indicative of a holed putt, or combination thereof. In one example, when a putt is identified as “in the hole,” the tracking data processing system 30 may run an optimization process, e.g., using the optimization engine 37, to find a simulation, e.g., generated by the path simulator 35, with a faster launch velocity that best matches the captured tracking data to use to reconstruct the tail of the path, e.g., using the path reconstruction unit. This may be performed when a base simulation, which ends at the hole as the captured shot end point, does not accurately represent the full path of a holed putt. For example, for putts that went in the hole, the tracking data processing system 30 may assume the tail data of path is incomplete since the ball disappears into the hole.

The optimization process may correspond to that described above to optimize parameters for generating an optimized simulation for use in reconstruction of one or more portions of the path. In one example, the tracking data processing system 30 performs a tail reconstruction, e.g., using the path reconstruction unit 33, to complete the path into the hole. In a further example, a matching algorithm is employed to find the best simulation match with speed increments up to a particular percent higher, e.g., 10% higher, than a base simulation. In various embodiments, paths that are detected as in the hole are fed to the surface speed processor 40 for surface speed application.

As introduced above, the tracking data processing system 30 may be configured to detect lip-outs by analyzing if a line segment of a path intersects with the hole and calculating a maximum angle change near this intersection. If the angle change exceeds a set threshold, e.g., 0.1 radians, the tracking data processing system 30 classifies the path as a lip-out.

In various embodiments, lip-outs may be detected by analyze path segments near the hole. A distance from the segment to hole center may be calculated and compared with the radius of the hole, typically 2.125 inches. Significant angle changes in the path may also be detected. The tracking data processing system 30 may be configured to classify the path as a lip-out if angle change exceeds a set threshold and the segment intersects with hole perimeter. To calculate distance from segment to hole center, the tracking data processing system 30 may be configured to calculates a minimum distance from a segment to the hole center. In one configuration, instead of directly calculating a minimum distance, the tracking data processing system 30 is configured to solve a quadratic equation that represents the intersection of the segment with the circular hole. In one example, the calculation is performed in the coordinate system of the data collection system 20. The quadratic equation may include coefficients derived from the segment's direction vector, the vector from the start point of the segment to the hole center, and the hole radius, e.g., 2.125 inches converted to feet. This approach directly determines whether the segment intersects with the hole perimeter without needing to calculate the minimum distance. In one embodiment, to compare with hole radius tracking data processing system 30 determines whether a segment intersects with the hole perimeter by solving a quadratic equation. The discriminant of this equation indicates whether there are intersection points. For example, if the discriminant is negative, there are no intersections. If the discriminant is non-negative, the tracking data processing system 30 calculates the intersection points and checks if they lie within the bounds of the segment, e.g., using parametric values between 0 and 1. This approach may be used to precisely determine whether any part of the segment passes through the perimeter of the hole. To detect significant angle changes in path, the tracking data processing system 30 may be configured to detects angle changes by calculating the angle (in radians) of each segment relative to the positive x-axis using the arctangent function, computing the difference between consecutive segment angles, normalizing this difference to be within the range [−π, π], and take the absolute value of this normalized difference. The tracking data processing system 30 may be configured with a set threshold for a “significant” angle change. For example, a significant angle change may be set to 0.1 radians (approximately 5.73 degrees). In one example, once a segment that intersects with the hole perimeter is identified, the tracking data processing system 30 analyzes the maximum angle change in the vicinity of the segment. If this maximum angle change exceeds a threshold, the entire putt is classified as a lip-out. For example, the tracking data processing system 30 may examine segments near the intersection point with the hole. The tracking data processing system 30 may looks at segments starting from n₁ segments before the intersection up to n₂ segments after. For instance, the tracking data processing system 30 may looks at segments starting from 1 segment before the intersection up to 2 segments after.

When a lip-out is detected, the tracking data processing system 30 may be configured to record the lip-out status in the analysis result, stores the index of the intersection segment, captures the start and end points of the intersection segment, and record the maximum angle change value. This information may be utilized in putt analysis processes to, e.g., optimize simulation parameters to better match the captured ball path up to the lip-out point, provide visual and analytical data about the lip-out event, adjust reconstruction of the ball path based on the lip-out characteristics, or combination thereof. Detection of a lip-out may change how the system 10 processes the putt, as it indicates a specific type of near-miss that may benefit from specialized handling in the simulation and analysis pipeline. In various embodiments, paths that are detected as lip-outs are not fed to the surface speed processor 40 for surface speed application. In another embodiment, only the portion of the path up to the lip-out may be used for calculating surface speed. In one embodiment, the tracking data processing system 30 analyze path portions after the lip-out and if sufficient points in the path and speed are present, use the path data after the lip-out in surface speed calculations.

As introduced above, when a lip-out is detected the tracking data processing system 30 may be configured to optimize the simulation using the portion of path captured in the tracking data up to the lip-out point to ensures the simulation accurately represents the approach to the hole before the lip-out occurs. The optimization process may correspond to that described above to optimize parameters for generating an optimized simulation for use in reconstruction of one or more portions of the path. In one example, the optimization approach for lip-outs may take a more aggressive approach with higher speed increments than employed for holed putts. For example, speed increments up to 10% higher may be used for optimization for holed putts and speed increments up to 30% higher may be used for optimization for lip-outs. In one embodiment, the tracking data processing system 30 is configured to store lip-out segment information, e.g., index, start and end coordinates.

The tracking data processing system 30 may be configured to perform path validation operations. For instance, utilizing the path validation unit 34, the tracking data processing system 30 may perform validation operations with respect to the path data. For example, the path simulator 35 generate a reference simulation path as described above. In some embodiments, the reference simulation path is generated in an Application coordinate system and then transformed to the Map coordinate system to match the captured path. The path validation unit 34 may compare the captured paths with simulated paths. The comparison between captured paths and simulated paths may include one or more of speed matching, path quality analysis, or lip-out detection. Speed matching may include comparison of speed profiles between captured paths and simulations. Path quality analysis may include an evaluation of how well the captured path matches the simulation. Lip-out detection may be similar to that described above and include analysis of a path to determine if the ball approached the hole but did not go in. Such comparisons may be employed to determine whether the captured tracking data is valid, which in some embodiments may comprise a validity layer in addition to filtering in sanitation operations, if the ball went in the hole or was a lip-out, and the quality of the tracking path capture by the imaging sensor 22. The validation may also include optimization of simulation parameters to match the captured path. The optimization of simulation parameters may be performed as described above with respect to the optimization operations of the optimization engine to match simulation data with captured path data for path reconstruction.

In various embodiments, the tracking data processing system 30 is configured to perform a path quality analysis. For instance, utilizing path validation unit 34, the tracking data processing system 30 may perform a path quality analysis to evaluate the quality of the captured path and a simulated path, either of which may include reconstructed portions. In some embodiments, simulated paths or portions, which may include reconstructed portions in captured or simulated paths, may be optimized as described above. In various embodiments, path quality analysis includes comparing a captured path with physics-based simulation path. The comparison may include calculating deviations between the paths. In one example, the comparison includes calculating point-by-point deviations in position, speed, and angle. The path quality analysis may include computing coverage metrics with respect to the path coverage represented in the captured path relative to the total path. In some embodiments, the path quality analysis may include calculating comparative quality metrics between reconstructed portions generated for incorporation in the captured path and simulated path. The metrics may be used to make a quality determinations, which may comprise generating quality scores via application of standards or thresholds. The path quality analysis may also include applying standards or thresholds to determine if the captured path, which may include reconstructed portions, is to be output for use in path generation, visualization, or analysis applications, e.g., with respect to use in scoring/tracking applications, is of sufficient quality or if the system 10 is to fall back on pure simulation.

In one example, the tracking data processing system 30, which may include utilization of the path validation unit 34, is configured to execute program instructions that configure it to perform a path quality analysis. The path quality analysis may comprise comparing captured path with physics-based simulations. The physics-based simulations may be generated as described herein with respect to the path simulator 35. In one example, the simulation is optimized. Simulations may be optimized as described herein before use in reconstruction and complete reconstructed paths may be derived from simulated data. For example, utilizing the path simulator 35, path reconstruction unit 36, and optimization engine 37, the tracking data processing system 30 may create a complete reconstructed path from the simulation data rather than using portions of captured data. Simulation parameters such as launch speed or direction may be extracted from captured data. However, the simulation may be optimized based on partial captured path data, e.g., for holed putts or lip-outs. The tracking data processing system 30 may adjust simulation parameters, such as launch speed, to better match available tracking data with respect to the captured path before using the simulation for reconstruction.

The path quality analysis may comprise calculating deviations in position, speed, and angle. This comparison between captured path and physics-based simulation may be performed on a point-by-point basis. For example, for each camera-captured point, the tracking data processing system 30 is configured to find the nearest corresponding point in the simulated path based on spatial proximity, e.g., using minimum Euclidean distance. For each segment of two consecutive points in the captured path, the tracking data processing system 30 may calculate the segment angle (direction of travel), calculate the segment speed, find the corresponding segment in the simulated path, and compute the differences in angle and speed between the camera and simulation segments. Using the above operations, the tracking data processing system 30 may be configured to not simply measure cumulative deviations from the start position, but rather analyze each segment independently and then aggregate these measurements to form quality metrics. However, in some embodiments, cumulative deviations may be measured. The angle comparison may specifically measure the difference between the captured segment's angle and the corresponding simulation segment's angle, which may be normalized to account for circular angle measurements, e.g., keeping differences within the range of −π to π.

The path quality analysis method may include computing coverage metrics as percentage of total path captured. The tracking data processing system 30 may define and compute various coverage metrics. Certain coverage metrics may incorporate total path, which may be defined as the complete simulated path from the starting point to the final resting or end point. Computation of coverage metrics may include executing one or more coverage computations. For example, the tracking data processing system 30 may be configured to calculate distance coverage. The distance coverage calculation may include calculation of a total length of the captured path and comparison of the total length to the total length of the simulated path. In the above or another example, the tracking data processing system 30 may be configured to calculate time coverage. The time coverage calculation may include calculation of the total time duration of the captured path and comparison of the total time duration to the total time duration of the simulated path. The tracking data processing system 30 may be configured to execute one or more percentage calculations with respect to coverage metrics. For example, a total coverage percentage, e.g., (Camera path length/Total simulation path length ×100, may be generated. In this or another example, a sanitized coverage percentage that calculates the percentage difference between the sanitized path length and the corresponding portion of the simulation path length. The sanitized path may be determined via application of a speed threshold multiplier as described above. Similar coverage percentage calculations may be performed time-based coverage, e.g., that compare the duration of the capture of the captured path to the duration of the simulation. In the above examples, simple thresholds or exact matches are not utilized, but rather continuous percentage values are calculated that reflect how much of the total expected path was captured by the camera. In other implementations, thresholds or matches may be used.

The path quality analysis method may include scoring or otherwise quantifying quality of path reconstruction. As described above, path reconstruction may include the process of creating a complete ball path using a combination of captured data and reconstructed segments derived from simulations. The reconstructed segments, e.g., portions, may include head reconstruction that fills in the beginning portion of a path that might be missing from tracking data. Additionally or alternatively, reconstructed segments may include tail reconstructions that fill in the end portion of a path, e.g., when a tracked ball goes into the hole on a green. The reconstructed path may include tracking data with respect to the path with one or more of these reconstructed segments, or in some cases, may fall back to using the physics-simulated path entirely. The tracking data processing system 30 may perform path quality measurements by calculating multiple quality metrics. The quality metrics may include one or more of average speed difference between captured and simulated paths, maximum position deviation of captured path from simulated path, coverage percentages (one or both of distance or time), or a path vs. direct distance ratio that measures of how much paths curves. Those having skill in the art will appreciate upon reading the present description that many methodologies may be used to quantify or otherwise evaluate quality based on the calculated quality metrics For example, the quality metrics may be scored or quantified by applying one or more standards or threshold determinations. However, the present description is not limited to such quantifications. In one example, specific thresholds, such as path vs. direct distance ratio >1.2, may be determined based on empirical analysis of what constitutes unrealistic tracking data. However, ratio values greater or less than 1.2 may be deemed unrealistic in some situations based on empirical analysis. In one embodiment, the tracking data processing system 30 may use a scoring approach that converts raw quality metrics into normalized scores, e.g., between 0 and 1. For example, for coverage metrics, scores closer to 1 may indicate better coverage.

The path quality analysis method may include determining whether to use camera data or fall back to simulation. For example, the tracking data processing system 30 may evaluate the normalized scores to determine whether to use camera data or fall back to simulation. Specific criteria may be utilized by the tracking data processing system 30 to determine whether to used captured path, which may include one or more restructured portions, or fallback to simulation. Fallback criteria for falling back to simulation may include sanitization of captured data fails (e.g., insufficient points or erratic data), the path vs. direct distance ratio exceeds threshold (e.g., greater than 1.2) indicating an abnormally curved path, or quality analysis fails to produce valid metrics. When the system 10 falls back to simulation, the system 10 uses a complete reconstructed path from the simulation data rather than using portions of camera data. In various embodiments, all subsequent calculations use the simulation reconstructed path derived from the physics-based simulation. When using simulation, the system 10 may typically use the full simulated path. However, the simulation may be optimized based on partial captured path data (e.g., for holed putts or lip-outs). As noted above, the tracking data processing system 30 may optimize simulations to adjust simulation parameters, such as launch speed, to better match available path data before using the simulation for reconstruction. However, as also noted above, the surface speed processor 40 generally does not use simulated reconstructed paths for surface speed calculations. For instance, in various embodiments configured to simulate paths, generate reconstructed paths, perform path quality analysis, or combination thereof, the surface speed processor 40 may be configured to not use any of a 100% simulation reconstructed path, and only use paths based on captured tracking data. In some examples, the paths based on captured tracking data may include some simulation elements with respect to head/tail reconstruction. Paths based on captured tracking data may include filtered or smoothed tracking data.

Thus, the tracking data processing system 30 may be configured to assess data quality and validity in its operations and address less representative data by processing the data, e.g., performing sanitization, smoothing, simulations, reconstruction, and optimizations to ensure data used by the system 10 is representative. This processing enables the system 10 to generate accurate output products and services in a dynamic, live environment utilizing automated capture and processing of tracking data. For instance, numerous situations may arise causing tracking data to be less representative that the system 10 may be configured to address. Example situations where tracking data may be less representative may include insufficient imaging sensor coverage cause the tracking data to miss one or more portions of a path, obstructed imaging sensor view, erratic or noisy tracking data with physically implausible movements, tracking data showing unrealistic path curvature, special cases like lip-outs where the imaging sensors 22 might not capture interactions, such as interactions with a hole.

While FIG. 5 depicts surface speed generation system 40, in some embodiments, the system 10 does not include the surface speed generation system 40. In these or other embodiments, the tracking system data processing system 30 does not include one or both of the sanitization unit 32 to filter tracking data or the data smoothing unit 33 to perform smoothing operations with respect to the tracking data. In any of the above or other embodiments, the tracking data processing system 30 does not include a path reconstruction unit 36 to reconstruct one or more portions of a path. In this or another embodiment, the tracking data processing system 30 does not include an optimization engine to optimize one or more portions of a path. In one embodiment, the tracking data processing system 30 does not include path validation unit 34.

The system 10 may implement various innovations. For example, unlike traditional stimpmeter or other surface speed unit readings taken under controlled conditions, the system 10 may be used to dynamically measure surface speed from actual competitive play, and do so dynamically to update measurements in-competition. While traditional methods provide only spot measurements, the system 10 may deployed to create complete surface map of speed variations to provide comprehensive spatial coverage. The system 10 may also automatically account for elevation changes, providing true friction-based stimp values independent of slope. The system 10 may also be configured to combine theoretical physics models with actual ball tracking to validate and enhance measurements. Adaptive window sizes and weighting may be used to provide more reliable measurements across varying conditions. The system 10 may also be configured to evaluate the reliability of its own measurements and can fall back to simulation when data quality is insufficient. Unlike traditional methods of measure green speed that require multiple rolls, the system may be configured to extract surface speed of a green from individual putts.

Path integration systems 50 of the system 10 may include tournament preparation enabling players to analyze green speed patterns before competition, broadcast enhancements to provide visualization of green speed for viewers during broadcasts, course maintenance applications to enable groundskeepers to identify inconsistencies in green conditions, player training to provide improved understanding of green or other surface speed effects on putting or roll, or historical analysis for comparison of green speeds across tournaments and seasons.

In one example, a path integration system 50 comprises integration of path data with scoring operations or tracking system 54 related thereto. For example, actual or simulated ball paths may be used to provide additional data to validate accuracy of associations. For instance, an actual or simulated path may be used to evaluate whether a putt is associated with the correct ball. This validation enables starting the audit process of stroke/putt association with balls earlier. Thus, if a stroke/putt is associated with a ball data associated with the path, which may include time of hit, whether the ball went in the hole, hole or zone location, position of the ball at start point, proximity to a hole at start or end point, or the like may be used to validate accuracy of scoring data entered into or collected via automation. The surface speed or path operations described herein may be utilized in score tracking systems such as those described in U.S. patent application Ser. No. Ser. No. 18/733,343, titled Golf Event Management System with Scoring and Location Tracking, U.S. patent application Ser. No. 18/995,995, titled Golf Tournament Management System, or U.S. patent application Ser. No. 18/949,970, titled Golf Tracking System for Monitoring and Management of Data, the contents of which are incorporated by reference herein.

In one embodiment, the surface speed process may be modified or extending to determine firmness of the ground. Additionally or alternatively, surface speed calculations with respect to fairways, rough, greens, or other surface may be applied to roll calculations for predicting bounce and roll to enhance predictions, e.g., in a final resting position predictions, such as in combination with final resting position predictions generated by the system described in U.S. patent application Ser. No. 18/976,002, titled System and Method for Estimating Final Resting Position of Golf Balls, the contents of which are incorporated by reference herein. Surface speed may be used to create an enhanced prediction that is much more accurate than predictions based on radar data only. These enhanced predictions may be used to set final endpoints of shots that are more accurate than those entered manually via interaction with a course display and plotting. Firmness calculations may similarly be utilized to enhance the prediction calculation for future shots.

In one embodiment, a path integration system 50 includes course setup system 56, such as those described in U.S. patent application Ser. No. 18/995,995, titled Golf Tournament Management System, the contents of which are incorporated by reference herein. In one example, output paths may be integrated for use to track speed of fairways, greens, or other surfaces over time and over an entire surface. Determination of ground firmness or changes thereto over time may be used aid in selection of hole locations in future rounds. Ground firmness, surface speed, or both may also be used to inform whether greens or fairways should be watered, or if grass should be mowed shorter or allowed to grow higher.

In one embodiment, a path integration system 50 includes broadcast enhancement system 52. The surface speed data or visualizations thereof may be used to show various iterations of speed of the greens and speed of putts over time. Paths may be used to show the actual distance and path the ball traveled across a surface, not just a straight line. Paths may be used to show distance left to right or right to left the ball curved.

In one embodiment, a path integration system 50 includes digital enhancement system 58. For example, green or fairway speeds may be visually displayed for each course over time by each shot or by aggregated shots.

The system 10 may be configured for computational efficiency for real-time analysis. For example, rather than compute surface speed after a putt or other ball roll event completes, the system 10 may be configured to compute/analyze the roll event as each captured coordinate is ingested by a system 10. So a putt with 60 coordinates would end up having 60 surface speed calculations total. In some examples, the first few points/calculations may be ignored due to lack of sufficient data where the ball has yet to enter a free roll after being hit.

The system 10 may be configured to integrate with existing course topology data. For example, coordinates captured by imaging sensors 22, such as cameras, having a Z value can effectively have their Z value ignored since putts roll on a surface. Instead, the Z value of the coordinates may be computed using the DTM data rather than use the Z value of the DTM data used by the camera system which can be slightly different.

The system 10 may be configured to account for weather effects on measurements, e.g., rain or humidity. Moisture on balls and the surfaces affects their ability to roll. This affects the friction and surface speed calculations. The system 10 may employ ground sensors to detect moisture. These readings may be used to predict how surface speed may change as the moisture increases or decreases.

While the present description generally describes collection of surface speed with respect to greens, the operations of the system be similarly applied to other areas of a golf course, such as fairways. In is to be further appreciated that the system and operations described herein may be applied to environments beyond golf. For instance, the system may be applied to other sports such as baseball, soccer, cricket, as examples, to determine surface parameters such as surface speed, hardness, or both. Such outputs may be utilized in various applications, such as visualization applications. In one example, the outputs may be used for prediction purposes. For instance, surface speed, hardness, or both may be used to increase accuracy of predictions with respect to bounce, roll, or final resting position of balls, which may be similar to that described above with respect to prediction of resting position of golf balls for application to betting, scoring, or tracking operations. Tracking operations may include providing accurate predicted positions of the ball at a future point in time for informing or directing broadcast or tracking sensors or personnel to the position.

It is also to be appreciated that while camera-based imaging is described herein, other imaging technology may additionally or alternatively be used. For example, in various embodiments, the tracking data comprises LiDAR-based imaging data collected by LiDAR, e.g., laser scanners, to track paths of objects across a surface, as described herein. The imaging data may be processed to generate actual paths, simulated path, reconstructed paths, or combination thereof. Additionally or alternatively, the imaging data may be processed to generate surface speed of the surface. These outputs may be utilized by the system or other systems as otherwise described herein.

The present disclosure is intended to be read to encompass one or more systems or components thereof comprising one or more processors and one or more tangible, non-transitory computer-readable media comprising program instructions stored therein, wherein the program instructions are executable by the one or more processors such that the system is configured to perform the operations described herein with respect to any of the various embodiments, examples, configurations, or implementations of the object path evaluation system 10 or components thereof. Such a system may comprise one or more computing devices, apparatuses, machines, or the like. As an example, the data collection system 20, tracking data processing system 30, surface speed processor 40, path integration systems 50, or the various processing units thereof, may include one or more processors and memories storing program instructions that when executed by the one or more processors perform the operations described herein with respect to system 10, including any one or more of data collection, tracking data processing, surface speed calculation, or visualization generation or other path integration operations. The one or more processors may share processing operations. The one or more processors, memories, or program instructions may be local or distributed among or between the components. Thus, terminology such as system, unit, engine, or the like do not require the memories, instructions stored therein, or processors to be physically located, stored, or operated at a single location or coded as a single unit. For example, operations of data smoothing unit 33 may be performed by same or different processors executing program instructions stored in same or different memories in same or different locations. The program instructions need not be provided as a same or single program, application, or tool. While the present disclosure may reference particular applications executed on one or more electronic devices, it is to be understood that such applications, including any application services, may be provided within a single application, program, or platform, or may be divided, virtualized, distributed, or combined into or among any number of executable platforms and resources.

At least a portion of the methodologies and techniques described with respect to the exemplary embodiments may incorporate a machine, such as, but not limited to a computer system or other computing device within which a set of instructions, when executed, may cause the machine to perform any one or more of the methodologies or functions discussed above. The machine may be configured to facilitate various operations conducted by the systems. For example, the machine may be configured to, but is not limited to, assist the systems by providing processing power to assist with processing loads experienced in the systems, by providing storage capacity for storing instructions or data traversing the systems, or by assisting with any other operations conducted by or within the systems. As another example, the computer system may assist with enhancing accuracy coordinates and information gleaned therefrom in a reduced infrastructure environment by incorporating rules such as error and/or warning rules that automatically identify potential discrepancies.

In some embodiments, the machine may operate as a standalone device. In some embodiments, the machine may be connected via a communications network to perform and/or assist with system operations, such as, but not limited to, receiving requests, translating coordinates, calculating distances, analyzing map data, simulating shots, predicting coordinates, collecting sensor data, identifying players, detecting balls, transmitting responses, communicating with the various databases, associated system servers, any other system, application, API, program, and/or device, or any combination thereof. The machine may be connected with any component in the systems. In a networked deployment, the machine may operate in the capacity of a server or a client user machine in a server-client user network environment, or as a peer machine in a peer-to-peer (or distributed) network environment, for example. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, the term “machine” shall also be taken to include any collection of machines that individually or jointly execute a set (or multiple sets) of instructions to perform any one or more of the methodologies discussed herein.

The computer system may include a processor (e.g., a central processing unit (CPU), a graphics processing unit (GPU), or both), a main memory and a static memory, which communicate with each other via a bus. The computer system may further include a video display unit, which may be, but is not limited to, a liquid crystal display (LCD), a flat panel, a solid state display, or a cathode ray tube (CRT). The computer system may include an input device, such as, but not limited to, a keyboard, a cursor control device, such as, but not limited to, a mouse, a disk drive unit, a signal generation device, such as, but not limited to, a speaker or remote control, and a network interface device. The disk drive unit may include a machine-readable medium on which is stored one or more sets of instructions, such as, but not limited to, software embodying any one or more of the methodologies or functions described herein, including those methods illustrated above. The instructions may also reside, completely or at least partially, within the main memory, the static memory, or within the processor, or a combination thereof, during execution thereof by the computer system. The main memory and the processor also may constitute machine-readable media.

Dedicated hardware implementations including, but not limited to, application specific integrated circuits, programmable logic arrays and other hardware devices can likewise be constructed to implement the methods described herein. Applications that may include the machine and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, methods described herein are intended for operation as software programs running on a computer processor. Furthermore, software implementations can include, but not limited to, distributed processing or component/object distributed processing, parallel processing, or virtual machine processing can also be constructed to implement the methods described herein.

In addition to or in alternative to the various embodiments and examples of the inventive concepts provided above, further non-limiting examples of the inventive concepts described herein are provided in the below clauses.

The present disclosure contemplates a machine-readable medium containing instructions so that a device, e.g., client device, coordinate translator, connected to a communications network, another network, or a combination thereof, can send or receive data, and communicate over the communications network, another network, or a combination thereof, using the instructions. The instructions may further be transmitted or received over the communications network, another network, or a combination thereof, via the network interface device. The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that causes the machine to perform any one or more of the methodologies of the present disclosure. The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

1. A system for calculating surface speed of a playing surface from image-captured ball movement, comprising:
one or more processors; and
one or more tangible, non-transitory computer-readable media storing program instructions that, when executed by the one or more processors, cause the system to:
receive or generate tracking data, the tracking data being generated from imaging data of the ball captured by one or more imaging sensors configured to track movement of the ball along the playing surface, the imaging sensors comprising cameras, LiDAR, or combinations thereof, the tracking data comprising sequential points with position coordinates and associated timestamps;
calculate a total deceleration from the tracking data, the calculation comprising polynomial fitting of position-time data with respect to a window of sequential points;
obtain elevation data for the sequential points from terrain data and calculate a slope component;
isolate a friction component by removing the slope component from the total deceleration;
convert the friction component to a surface speed value using a physics-based conversion factor; and
output the surface speed value as a measurement of surface speed for the playing surface.

2. The system of claim 1, wherein the imaging sensors comprise cameras calibrated to a coordinate system of the playing surface using anchor points fixed on the playing surface, and the position coordinates are tracked within the coordinate system.

3. (canceled)

4. The system of claim 1, wherein the system retrieves elevation values for the sequential points from a digital terrain model using bilinear interpolation, and determines the slope angle between consecutive points from the elevation values.

5. The system of claim 1, wherein the system converts the friction component to a friction coefficient using (−friction_acceleration)/(g·cos(slope_angle)) and applies the physics-based conversion factor to the friction coefficient to generate the surface speed value.

6. A system for calculating surface speed of a playing surface from image-captured ball movement, comprising:
one or more processors; and
one or more tangible, non-transitory computer-readable media storing program instructions that, when executed by the one or more processors, cause the system to:
receive or generate tracking data, the tracking data being generated from imaging data of the ball captured by one or more imaging sensors configured to track movement of the ball along the playing surface, the imaging sensors comprising cameras, LiDAR, or combinations thereof, the tracking data comprising sequential points with position coordinates and associated timestamps;
calculate a total deceleration from the tracking data;
obtain elevation data for the sequential points from terrain data and calculate a slope component;
isolate a friction component by removing the slope component from the total deceleration;
convert the friction component to a surface speed value using a physics-based conversion factor;
and
output the surface speed value as a measurement of surface speed for the playing surface,
wherein the program instructions, when executed, further cause the system to apply weighted averaging across multiple points, and wherein the weighted averaging comprises: group points into overlapping windows, calculate a surface speed value for each window, and attribute the surface speed value to points in the window with different weights

7. The system of claim 6, wherein the weights in each window are determined by a triangular distribution based on distance to a window midpoint and normalized to sum to 1.0.

8. The system of claim 1, wherein the program instructions, when executed, further cause the system to ignore initial sequential points until sufficient data exists for the ball to enter free roll after being hit.

9. The system of claim 1, wherein the program instructions, when executed, further cause the system to cease processing additional windows of sequential points when a point speed falls below a defined speed threshold.

10. The system of claim 1, wherein the program instructions, when executed, further cause the system to generate the surface speed value with a processing latency of less than one second from receipt of a final sequential point used in the calculation during play.

11. The system of claim 1, wherein the program instructions, when executed, further cause the system to receive tracking data captured at timestamp intervals between 0.02 seconds and 0.1 seconds.

12. The system of claim 1, wherein the program instructions, when executed, further cause the system to exclude, from the surface speed calculation, sequential points derived from simulated or reconstructed path segments such that the surface speed value is generated exclusively from captured tracking data.

13. The system of claim 1, wherein the program instructions, when executed, further cause the system to generate the tracking data by performing operations comprising:
capture of image frames using one or more cameras;
detection and tracking of the ball in successive frames using computer vision to determine pixel locations of the ball;
transformation of the pixel locations to position coordinates in a mapped coordinate system using a coordinate translator configured with anchor points;
association of timestamps synchronized to a common time base with the position coordinates; and
output of sequential points comprising the position coordinates and associated timestamps.

14. The system of claim 13, wherein the program instructions, when executed, further cause the system to fuse tracking data from cameras having overlapping fields of view by selecting a most complete path or a path most consistent with a physics-based simulation and excluding erratic or aberrant portions inconsistent with the selected path.

15. A method for calculating surface speed of a playing surface from image-captured ball movement, comprising:
receiving or generating tracking data, the tracking data being generated from imaging data of the ball captured by one or more imaging sensors configured to track movement of the ball along the playing surface, the imaging sensors comprising cameras, LiDAR, or combinations thereof, the tracking data comprising sequential points with position coordinates and associated timestamps;
calculating a total deceleration from the tracking data comprising performing polynomial fitting of position-time data with respect to a window of sequential points;
obtaining elevation data for the sequential points from terrain data and calculating a slope component;
isolating a friction component by removing the slope component from the total deceleration;
converting the friction component to a surface speed value using a physics-based conversion factor; and
outputting the surface speed value as a measurement of surface speed for the playing surface.

16. (canceled)

17. The method of claim 15, wherein obtaining elevation data comprises retrieving elevation values for the sequential points from a digital terrain model using bilinear interpolation, and wherein calculating the slope component comprises determining a slope angle between consecutive points from the elevation values.

18. The method of claim 15, wherein converting the friction component to a surface speed value comprises converting the friction component to a friction coefficient using (−friction_acceleration)/(g·cos(slope_angle)) and applying the physics-based conversion factor to the friction coefficient.

19. The method of claim 15, further comprising generating the tracking data by performing operations comprising:
capture of image frames using one or more cameras;
detection and tracking of the ball in successive frames using computer vision to determine pixel locations of the ball;
transformation of the pixel locations to position coordinates in a mapped coordinate system using a coordinate translator configured with anchor points;
association of timestamps synchronized to a common time base with the position coordinates; and
output of sequential points comprising the position coordinates and associated timestamps.

20. A non-transitory computer-readable medium storing program instructions that, when executed by one or more processors, cause the one or more processors to:
receive or generate tracking data, the tracking data being generated from imaging data of the ball captured by one or more imaging sensors configured to track movement of the ball along the playing surface, the imaging sensors comprising cameras, LiDAR, or combinations thereof, the tracking data comprising sequential points with position coordinates and associated timestamps;
calculate a total deceleration from the tracking data, the calculation comprising polynomial fitting of position-time data with respect to a window of sequential points;
obtain elevation data for the sequential points from terrain data and calculate a slope component;
isolate a friction component by removing the slope component from the total deceleration;
convert the friction component to a surface speed value using a physics-based conversion factor; and
output the surface speed value as a measurement of surface speed for the playing surface.
